(19) United States
(12) Patent Application Publication
(10) Pub. No.: US 2006/0214917 A1
(43) Pub. Date: Sep. 28, 2006

(54) Key function switching method and system

(75) Inventor: Dick Liu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/088,646

(22) Filed: Mar. 23, 2005

(51) Int. Cl. G09G 5/00

(52) U.S. Cl. 345/172

(57) ABSTRACT

A key function switching method and a key function switching system are applicable to an electronic device. The system makes the electronic device generate a key function switching operating interface to provide an option of activating specific key function switching for a user. The system makes the electronic device store a setting received by the key function switching operating interface. During a Power-on Self-Test procedure of the electronic device, the system makes the electronic device read the stored setting and temporarily store it in a memory unit. The system then makes the electronic device detect whether a key being used corresponds to the key having a function of the specific key function switching, if so, determining whether the setting stored in the memory unit indicates the specific key function switching is activated, and if the specific key function switching is activated, performing the specific key function switching.

### FIELD OF THE INVENTION

The present invention relates to systems and method for switching key functions, and more particularly, to a key function switching system and method applicable to an electronic device.

### BACKGROUND OF THE INVENTION

Due to continuous evolution of electronics technologies, a variety of electronic devices or systems have come into existence providing a wide range of functionalities and ever-increasing data processing performance. Additionally, the improvement in manufacturing of electronic devices brings about miniaturization of the devices.

In notebook computers, “Hot Keys” are provided for the users to swiftly execute a certain function or program corresponding to a particular Hot Key, for example, connecting to a network or opening a media player etc. However, the keyboard provided on the notebook computer is limited and usually inextensible, so a “Fn Key” is provided to define additional functionalities by combining with other keys. Thus, more functionality can be achieved under the limited number of keys on the keyboard. This resolves the dilemma faced with providing more functions in an electronic device while seeking to miniaturize the size of the device.

Since the “Fn Key” is used frequently in the notebook computer, its location on the keyboard affects the convenience when operating the notebook computer. Normally, the “Fn Key” is arranged to either the left or right of the “Left Ctrl Key”. Both keys are often used by the users.

However, some people are used to select only one of the “Left Ctrl Key” and “Fn Key” . Since the two keys are located beside each other, thus a user may accidentally select the “Left Ctrl Key” when he/she meant to select the “Fn Key”, or vice versa. This causes problem for the user, especially, if the wrongly selected key results in undesirable function being executed. For example, when a user wants to save a document, but instead, gets a shutdown function due to pressing the wrong key.

Thus, a more efficient key function switching method and system is needed to solve inconvenience when operating an electronic device with limited number of keys and space.

### SUMMARY OF THE INVENTION

In light of the above drawbacks, the primary objective of the present invention is to provide a key function switching method and system, allowing functions of different keys to be exchanged.

Another objective of the present invention is to provide a key function switching method and system for switching functions of different keys via a software mechanism.

In order to achieve the above and other objectives, the present invention proposes a key function switching system applicable to an electronic device. The system comprises: a setting module for generating a key function switching operating interface for allowing a user to select whether to enable specific key function switching; a storage unit for storing the selection result received by the key function switching operating interface; a key controlling module for determining the stored selection result during a Power-On Self-Test (POST) procedure of the electronic device and temporarily storing the selection result in a memory unit; and a switching module for determining whether the specific key function switching of a key pressed by the user is enabled based on the selection result temporarily stored in the memory unit, and performing the specific key function switching if it is determined that the specific key function switching of the key is enabled.

The present invention also proposes a key function switching method applicable to an electronic device. The method comprises the steps of: generating a key function switching operating interface for allowing a user to select whether to enable specific key function switching; storing the selection result received by the key function switching operating interface; reading the stored selection result during a Power-On Self-Test (POST) procedure of the electronic device and temporarily storing the selection result in a memory unit; and determining whether the specific key function switching of a key pressed by the user is enabled based on the selection result temporarily stored in the memory unit, if so, performing the specific key function switching.

Compared to the convention key controlling techniques, the key function switching method and system in the present invention enables functions of different keys to be switched based on the software mechanism. Through the use of the key function switching method and system, the user can set a specific key function switching according to their own preference.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing systemic architecture of a key function switching system according to the present invention; and

FIG. 2 is a flowchart shows steps of a key function switching method according to the present invention.

### DETAILED DESCRIPTION OF THE PREFERRED EMBODIMENTS

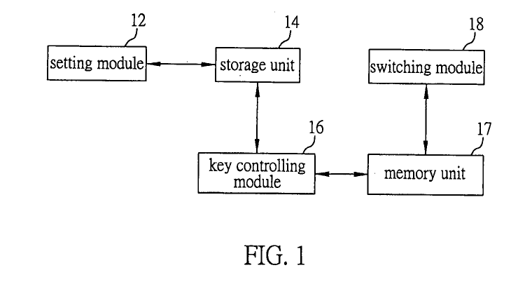

FIG. 1 is a schematic diagram showing systemic architecture of a key function switching system according to the present invention. As shown in FIG. 1, the system comprises a setting module 12, a storage unit 14, a key controlling module 16 and a switching module 18. The key function switching system in the present invention is applicable to an electronic device such as, but not limited to, a notebook computer. It is to be noted that the key function switching system can also be applied to other electronic devices with keys, such as an electronic dictionary, desktop computer and PDA (Personal Digital Assistance). Moreover, the system is constructed in the BIOS (Basic Input/Output System) of the notebook computer. In this embodiment, two functional keys “Left Ctrl Key” and “Fn Key” are used in the description of key function switching. However, other functional keys and/or more than two keys can be subjected to switching as desired.

The setting module 12 is used to generate a key function switching operating interface providing an option for a user to activate specific key function switching. As already mentioned above, the setting module 12 is constructed in the BIOS, the user may enter the BIOS setting page by pressing “Delete” key during a standard booting of the electronic device. The setting page includes a key switching setting option, which may be selected by the user via an input unit such as a keyboard (not shown). Upon selection of the key switching setting option, the setting module 12 generates a key function switching operating interface, wherein options would be generated to inquire the user if he/she wishes to activate the function switching between the “Left Ctrl Key” and the “Fn Key”.

The storage unit 14 is used to store the selection made by the user through the options provided the key function switching operating interface generated by the setting module 12. As described above, after the options are generated to inquire the user if he/she wishes to activate the function switching, and a “Yes” option selected by the user via an input unit (not shown) is stored in the storage unit 14. The storage unit 14 can be an electrically erasable programmable non-volatile memory, such as a CMOS (Complimentary Metal-Oxide Semiconductor) memory or a Flash memory. It is to be noted that in this embodiment, the setting program in the BIOS uses an interrupt service of INT 15 to set or clear a specific bit in the storage unit 14 for storing the enabling or disenabling status of the specific key function switching. For example, when the switching is enabled, the specific bit is set to “1”; or, when the switching is disabled, the specific bit is set to “0”. As described before, in this embodiment, the specific bit is set to “1”.

The key controlling module 16 is used to determine the selection stored in the storage unit 14 during a POST (Power-On Self-Test) procedure of the electronic device and store it in a memory unit 17. In this embodiment, after the key function switching status set by the user is stored in the specific bit of the storage unit 14, the computer is restarted. During the POST, a POST program would notify the key controlling module 16 of the status of the specific bit in the storage unit 14, so that the key controlling module 16 temporarily stores the status into the memory unit 17, providing a reference for a key controlling program when it is executed. The memory unit 17 can be for example a volatile memory, e.g. a SRAM (Static Random Access Memory).

The switching module 18 is used to detect whether a specific key having a function of the specific key function switching is selected by the user. When the status of key function switching temporarily stored in the memory unit 17 is enabled, the specific key function switching is performed. In this embodiment, when a key is being pressed, the switching module 18 obtains the scan code for the pressed key via scan lines. Then, the switching status stored in the memory unit 17 is determined before processing the scan code. If the switching is enabled, the key function switching is performed; or else, the scan code is executed directly. When the key function switching is performed, it is firstly determined whether the scan code indicates a “Left Ctrl Key” or a “Fn key”, if so, then the scan codes for “Left Ctrl Key” and the “Fn key” are exchanged, and the function corresponding to the scan code after switching is performed. That is, if the “Left Ctrl Key” is pressed, the function of the “Fn Key” is performed instead.

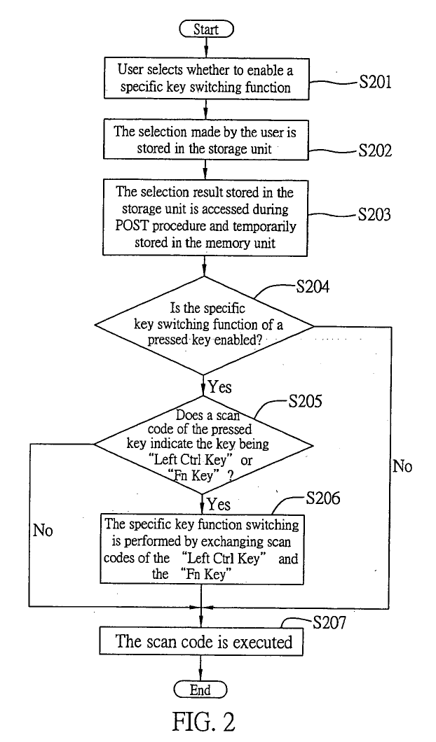

FIG. 2 is a flowchart shows steps of a key function switching method according to the present invention. The key function switching method can be applied to an electronic device with keys, such as an electronic dictionary, desktop computer, notebook computer and PDA. The key function switching method is described in view of components in the key function switching system described above.

In step S201, a key function switching operating interface is firstly generated via the setting module 12, wherein this key function switching operating interface can be a selection menu displayed on a monitor (not shown) of the electronic device, allowing a user to select the options of enable or disable specific key function switching. In this embodiment, when the user presses the “Delete”key during the POST of electronic device, a BIOS function setting page is entered. Upon entering, the user may then select via an input unit (e.g. keyboard) the key function switching setting option. Thereafter, the key function switching operating interface is generated by the setting module 12, and an option is displayed to inquire whether the user would like to switch or exchange the functions of the “Left Ctrl Key” and the “Fn Key”. The user then selects the enable or disenable option via the input unit. Then, step S202 is entered.

In step S202, the selection result received by the key function switching operating interface is stored in the storage unit 14. In this embodiment, upon displaying the options of switching functions of the “Left Ctrl Key” and the “Fn Key” and the user selecting “YES” to enable the switching, the result is stored in the storage unit 14. Specifically, a BIOS setting program sets a specific bit in the storage unit 14 to “1” via an interrupt service of INT 15 in response to the key function switching enabling option selected by the user. Then, step S203 is entered.

In step S203, the key function switching status stored in the storage unit 14 is accessed by the key controlling module 16 during the POST procedure and temporarily stored in the memory unit 17. In this embodiment, after the key function switching status set by the user is stored in the specific bit of the storage unit 14, the electronic device is restarted. During the POST procedure of the electronic device, a POST program would notify the key controlling module 16 of the status of the specific bit in the storage unit 14, so that the key controlling module 16 stores the status into its memory unit 17, providing a reference for a key controlling program when it is executed. Then, step S204 is performed.

In step S204, the selecting module 18 detects whether the specific function switching of a key, when being pressed, is enabled or disenabled. When the status of key function switching temporarily stored in the memory unit 17 is enabled, the specific key function switching is performed. In this embodiment, when a key is being pressed, the switching module 18 obtains the scan code for the pressed key via scan lines. Then, the switching status stored in the memory unit is determined before processing the scan code. If the switching is enabled, then step S205 is performed; or else, step S207 executed.

In step S205, upon determining the key function switching option is enabled, the selection module 18 further determines whether the scan code indicates one of a “Left Ctrl Key” and a “Fn key”, if so, then step S206 is performed, or else step S207 is entered.

In step S206, the scan codes for “Left Ctrl Key” and the “Fn key” are exchanged by the switching module 18, and the function corresponding to the scan code after switching is executed. That is, if the “Left Ctrl Key” is pressed, the function of the “Fn Key” is performed instead.

In step S207, the scan code is executed.

In summary, the key function switching method and the system in the present invention allows the setting of key function switching via a software mechanism, so that the functions of different keys can be exchanged. Through the use of the key function switching method and system, the user can set a specific key function switching according to their own preference.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A key function switching method applicable to an electronic device, the method comprising the steps of:
generating a key function switching operating interface for allowing a user to select whether to enable specific key function switching;
storing the selection result received by the key function switching operating interface;
reading the stored selection result during a Power-On Self-Test (POST) procedure of the electronic device and temporarily storing the selection result in a memory unit; and
determining whether the specific key function switching of a key pressed by the user is enabled based on the selection result temporarily stored in the memory unit, if so, performing the specific key function switching.

2. The method as claimed in claim 1, which is performed by a BIOS (Basic Input/Output System) of the electronic device.

3. The method as claimed in claim 2, wherein a setting program in the BIOS performs a setting or clearing process on a specific bit via an interrupt service of INT 15 based on whether the specific key function switching is enabled or not.

4. The method as claimed in claim 3, wherein when the specific key function switching is enabled, the specific bit is set to one by the interrupt service, or when the specific key function switching is not enabled, the specific bit is cleared to zero.

5. The method as claimed in claim 1, wherein the selection result received by the key function switching operating interface is stored in an electrically erasable programmable non-volatile memory of the electronic device.

6. The method as claimed in claim 5, wherein the electrically erasable programmable non-volatile memory is a CMOS (Complimentary Metal-Oxide Semiconductor) memory or a Flash memory.

7. The method as claimed in claim 1, wherein the memory unit is a volatile random access memory.

8. The method as claimed in claim 1, wherein the electronic device is one selected from the group consisting of an electronic dictionary, a desktop computer, a notebook computer and a PDA (Personal Digital Assistance).

9. The method as claimed in claim 1, wherein the specific key is a “Left Ctrl Key” or a “Fn Key”.

10. A key function switching system applicable to an electronic device, the system comprising:
a setting module for generating a key function switching operating interface for allowing a user to select whether to enable specific key function switching;
a storage unit for storing the selection result received by the key function switching operating interface;
a key controlling module for determining the stored selection result during a Power-On Self-Test (POST) procedure of the electronic device and temporarily storing the selection result in a memory unit; and
a switching module for determining whether the specific key function switching of a key pressed by the user is enabled based on the selection result temporarily stored in the memory unit, and performing the specific key function switching if it is determined that the specific key function switching of the key is enabled.

11. The system as claimed in claim 10, wherein the modules are software programs, firmware or hardware.

12. The system as claimed in claim 11, wherein the modules are constructed in a BIOS (Basic Input/Output System) of the electronic device.

13. The system as claimed in claim 12, wherein a setting program in the BIOS performs a setting or clearing process on a specific bit via an interrupt service of INT 15 based on whether the specific key function switching is enabled or not.

14. The system as claimed in claim 13, wherein when the specific key function switching is enabled, the specific bit is set to one by the interrupt service, or when the specific key function switching is not enabled, the specific bit is cleared to zero.

15. The system as claimed in claim 10, wherein the storage unit is an electrically erasable programmable non-volatile memory.

16. The system as claimed in claim 15, wherein the electrically erasable programmable non-volatile memory is a CMOS (Complimentary Metal-Oxide Semiconductor) memory or a Flash memory.

17. The system as claimed in claim 10, wherein the memory unit is a volatile random access memory.

18. The system as claimed in claim 10, wherein the electronic device is one selected from the group consisting of an electronic dictionary, a desktop computer, a notebook computer and a PDA (Personal Digital Assistance).

19. The system as claimed in claim 10, wherein the specific key is a “Left Ctrl Key” or a “Fn Key”.
